(19) United States
(12) Patent Application Publication
(10) Pub. No.: US 2021/0066732 A1
(43) Pub. Date: Mar. 4, 2021

(54) FUEL CELL SYSTEM HAVING A MEDIUM PRESSURE TAP ASSOCIATED WITH THE COMPRESSOR AND USE OF SUCH A FUEL CELL SYSTEM

(71) Applicants: AUDI AG, Ingolstadt (DE); VOLKSWAGEN AG, Wolfsburg (DE)

(72) Inventors: Dirk JENSSEN, Braunschweig (DE); Christian LUCAS, Braunschweig (DE)

(21) Appl. No.: 16/962,194

(22) PCT Filed: Jan. 11, 2019
(86) PCT No.: PCT/EP2019/050670

§ 371 Date: Jul. 14, 2020

(30) Foreign Application Priority Data
Jan. 17, 2018 (DE) 10 2018 200 681.4

(51) Int. Cl. H01M 8/04089; H01M 8/04111; H01M 8/04223; H01M 8/04302; H01M 8/2484

(52) U.S. Cl. CPC H01M 8/04097; H01M 8/04111; H01M 8/2484; H01M 8/04302; H01M 8/04231

(57) ABSTRACT

A fuel cell system includes at least one membrane electrode assembly arranged in a housing, a cathode supply having a compressor, and a device for housing ventilation, the device for housing ventilation having a medium pressure tap associated with the compressor. Such a fuel cell system may be used to perform a method for cathode recirculation.

### BACKGROUND

### Technical Field

Embodiments of the invention relate to a fuel cell system comprising at least one membrane electrode assembly arranged in a housing, a cathode supply having a compressor and a device for housing ventilation. Embodiments of the invention further relate to the use of the fuel cell system for cathode recirculation.

### Description of the Related Art

A fuel cell system is used for generating electrical energy by reacting a fuel, in particular hydrogen, with oxygen using the membrane electrode assembly, which has a proton-conducting membrane with an anode electrode on one side and a cathode electrode on the other side. In order to increase the electrical energy provided, a plurality of membrane electrode assemblies are generally combined to form a stack arranged in the housing. During operation of the fuel cell system, care must be taken that a quantity of oxygen sufficient for the quantity of hydrogen provided is introduced into the housing. In order to ensure that is the case, the compressor is provided.

It should also be noted that hydrogen diffuses from the membrane electrode assembly into the housing, so that the device for housing ventilation is required to avoid a combustible mixture within the housing.

DE 10 2015 220 641 A1 discloses in this respect, as belonging to the prior art, that an independent blower is used as additional component in order to ensure adequate ventilation of the housing. This blower represents an additional component which increases the space requirement and the necessary energy requirement for operating the fuel cell system.

DE 10 2013 003 470 A1 shows a fuel cell system in which the housing has at least one ventilation connection to the environment, and an independent flow to the housing is generated during operation of the compressor as an air conveying device.

In DE 10 31 238 A1, the housing of a fuel cell system is ventilated by explosion-proof fans.

### BRIEF SUMMARY

In some embodiments, a fuel cell system of the type mentioned at the outset is designed in such a way that the structure is simplified and the energy requirement is reduced. A further object is to specify a simple method for cathode recirculation.

The part of the object relating to the device is achieved by a fuel cell system comprising at least one membrane electrode assembly arranged in a housing, a cathode supply having a compressor and a device for housing ventilation, the device for housing ventilation having a medium pressure tap associated with the compressor.

Such a fuel cell system is characterized in that a blower for housing ventilation can be completely omitted, that is to say, this component is dispensed with along with the energy input required for operating this component. In addition, use is made of the fact that an air flow is already provided by the compressor. Energy is required for compressing the air flow and the heating thereof that occurs in the process. Embodiments of the invention further optimize the energy input, not only by dispensing with the blower, but also by recognizing that fully compressed air is not required for ventilation, but that a sufficient quantity of air for housing ventilation is also provided at a lower pressure and the medium pressure tap associated with the compressor can be used for housing ventilation. Energy-intensive generation of high pressure solely for the purpose of housing ventilation is avoided.

The compressor may have an outlet opening in the region of a medium pressure internally present during operation, said outlet opening being connected via a pressure line to a housing opening of the housing. The medium pressure tap can thus be implemented in a particularly simple manner by forming in the compressor an outlet opening which can be connected to the pressure line otherwise used for the blower.

A valve may be associated with the outlet opening and/or the pressure line and/or the housing opening. In this case, the valve can be designed as a passive valve which opens automatically when a minimum pressure is exceeded. This ensures that the housing ventilation is only in operating mode when a sufficient quantity of air is also available, that is to say, every air flow in the pressure line leads to reliable housing ventilation, which potentially simplifies monitoring and regulation. An active throttle element may be associated with the medium pressure tap, said throttle element in turn being able to regulate the amount of air tapped, for example, as a function of the measured values of a hydrogen sensor arranged in the housing.

The compressor may be selected from a group comprising screw compressors and Roots compressors. In a screw compressor, for example, the pressure increases continuously in the longitudinal direction of the screw, so that the medium pressure tap takes place simply by arranging the outlet opening in the center of the compressor, that is to say, at a sufficient distance from its ends.

In order to prevent the device for housing ventilation from building up within the housing an increased pressure which counteracts the inflow of further air, the housing has an outlet opening for housing ventilation. This outlet opening can most easily lead into the open outdoor environment. However, a venting line may run from the outlet opening to a turbine outlet downstream of a turbine in order to be able to use the compressed air provided by the compressor further in this way. It is then expedient for a first shut-off valve to be arranged upstream of the compressor and for a second shut-off valve to be arranged at the turbine outlet downstream of the connection of the venting line.

With such a structural design, it is possible to achieve the partial object concerning the method, namely the use of the fuel cell system for implementing cathode recirculation, comprising the following steps:
Closing the first shut-off valve, closing the second shut-off valve, sucking in gas from the housing by means of the compressor through the medium pressure tap, compressing the gas downstream of the medium pressure tap up to the compressor outlet, and conducting the gas through the housing to the turbine and via the venting line through the housing back to the compressor.

A further disadvantage of operating a fuel cell can thus be mitigated or even eliminated, namely damage to the fuel cell if oxygen is present on the anode side and cathode side of the membrane electrode assembly during a start, which leads to the problems of an air-air start which occur whenever oxygen input takes place after the fuel cell system is switched off In this case, cathode recirculation serves the purpose of reacting away the remaining oxygen by circulating the system closed by the first shut-off valve and the second shut-off valve.

### BRIEF DESCRIPTION OF THE SEVERAL VIEWS OF THE DRAWINGS

FIG. 1 illustrates a schematic, simplified illustration of a fuel cell system with a compressor modified for the medium pressure tap,

FIG. 2 illustrates a fuel cell system similar to that of FIG. 1 with a venting line associated with the outlet opening of the housing,

FIG. 3 illustrates a fuel cell system similar to that of FIG. 1 suitable for use for cathode recirculation, and

FIG. 4 illustrates a screw compressor comprising the medium pressure tap.

### DETAILED DESCRIPTION

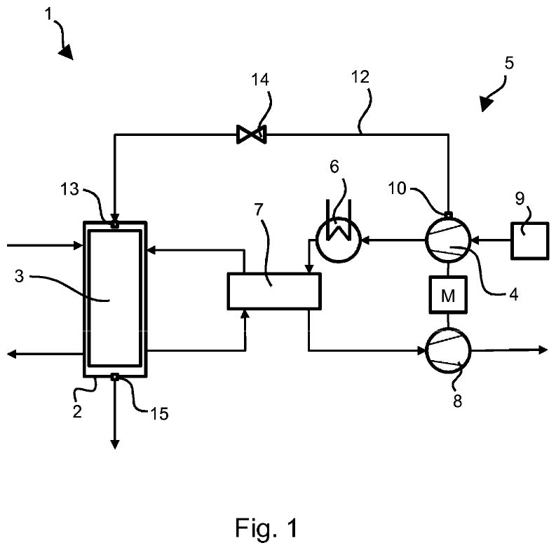

FIG. 1 schematically shows a fuel cell system 1 in which a plurality of membrane electrode assemblies 3 are combined to form a stack which is symbolized by a rectangle and is arranged in a housing 2. For operation, this stack must be supplied with operating media, i.e., firstly with the fuel, in particular hydrogen or a hydrogen-containing gas mixture, and secondly with an oxygen-containing gas mixture, in particular air, which forms the cathode operating medium. This air is supplied through a filter to a compressor 4 in which it is compressed and therefore heated. The air is supplied via a charge air cooler 6 to a humidifier 7 and from it to the stack.

The hydrogen supplied to the fuel cell 1 can diffuse out of said fuel cell into the housing 2, so that there exists a risk of a combustible mixture accumulating. This is prevented by a device for housing ventilation, which is implemented with a medium pressure tap 10 associated with the compressor 4.

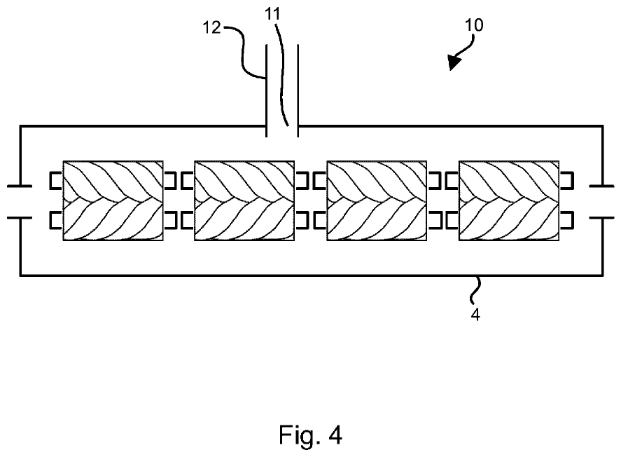

According to the design shown in FIG. 4, the compressor 4 can be designed as a screw compressor in which the pressure continuously increases along the longitudinal direction of the screw. If a bore is introduced into the wall of the compressor 4 as the outlet opening 11, the pressure corresponding to the compressor length prevails at said bore and can be referred to as the medium pressure in comparison to the pressure present at the inlet of the compressor 4 and at the outlet of the compressor 4.

The outlet opening 11 associated with the compressor 4 is connected via a pressure line 12 to a housing opening 13 of the housing 2, wherein a valve 14 can be associated with the outlet opening 11 and/or the pressure line 12 and/or the housing opening 13. In the exemplary embodiments shown in FIGS. 1 to 3, the valve 14 is arranged in the pressure line 12, wherein the valve 14 can be designed as a passive valve which opens automatically when a minimum pressure is exceeded in order to ensure that there is an air flow in the pressure line 12 only if the mass flow is also sufficient to ensure the desired housing ventilation. It is also possible for an active throttle element to be associated with the medium pressure tap 10, said throttle element also being designed as a valve in order to be able to set an upper limit in addition to a lower limit for the mass flow so as to avoid more air being tapped from the compressor 4 than is required for achieving the desired housing ventilation.

In the exemplary embodiment shown in FIG. 1, the housing 2 has an outlet opening 15 for housing ventilation, which opening thus discharges the air to the environment.

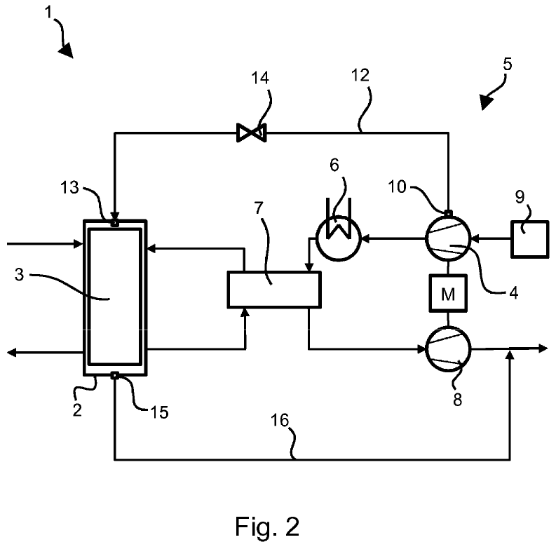

FIG. 2 shows an alternative exemplary embodiment in which a venting line 16 runs from the outlet opening 15 to a turbine outlet downstream of a turbine 8 so that the air supplied from the compressor 4 to the housing 2 via the medium pressure tap 10 can be used further after use in the housing 2.

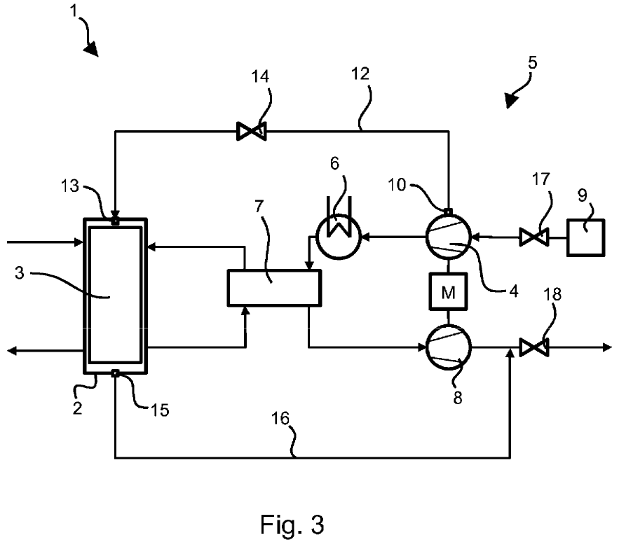

FIG. 3 shows another exemplary embodiment in which a first shut-off valve 17 is arranged upstream of the compressor 4 and a second shut-off valve 18 is arranged at the turbine outlet downstream of the connection of the venting line. In this embodiment, cathode recirculation can be implemented in a simple manner, which serves to avoid the problem of a so-called air-air start after the restart of a switched-off system, which problem occurs when oxygen is present on the anode side and cathode side of the membranes of the membrane electrode assemblies 3. Cathode recirculation is initiated upon restart of the fuel cell system by closing the first shut-off valve 17, closing the second shut-off valve 18, and sucking in gas from the housing 2 by means of the compressor 4 through the medium pressure tap 10. The gas entering the compressor 4 through the medium pressure tap 10 is compressed up to the compressor outlet and then flows through the housing 2 to the turbine 8 and via the venting line 16 through the housing 2 back to the compressor 4. The cathode recirculation causes the residual oxygen present to react.

In general, in the following claims, the terms used should not be construed to limit the claims to the specific embodiments disclosed in the specification and the claims, but should be construed to include all possible embodiments along with the full scope of equivalents to which such claims are entitled.

1. A fuel cell system comprising:
at least one membrane electrode assembly arranged in a housing;
a cathode supply having a compressor; and
a device for housing ventilation,
wherein the device for housing ventilation has a medium pressure tap associated with the compressor.

2. The fuel cell system according to claim 1, wherein the compressor has an outlet opening in a region of a medium pressure internally present during operation, said outlet opening being connected via a pressure line to a housing opening of the housing.

3. The fuel cell system according to claim 2, wherein a valve is associated with the outlet opening, the pressure line, and/or the housing opening.

4. The fuel cell system according to claim 3, wherein the valve is a passive valve which opens automatically when a minimum pressure is exceeded.

5. The fuel cell system according to claim 1, wherein an active throttle element is associated with the medium pressure tap.

6. The fuel cell system according to claim 1, wherein the compressor is selected from a group consisting of screw compressors and Roots compressors.

7. The fuel cell system according to claim 1, wherein the housing has an outlet opening for housing ventilation.

8. The fuel cell system according to claim 7, wherein a venting line runs from the outlet opening to a turbine outlet downstream of a turbine.

9. The fuel cell system according to claim 8, wherein a first shut-off valve is arranged upstream of the compressor and a second shut-off valve is arranged at the turbine outlet downstream of the connection of the venting line.

10. A method of using the fuel cell system according to claim 9 for implementing cathode recirculation, comprising:
closing the first shut-off valve;
closing the second shut-off valve;
sucking in gas from the housing by means of the compressor through the medium pressure tap;
compressing the gas downstream of the medium pressure tap up to the compressor outlet; and
conducting the gas through the housing to the turbine and via the venting line through the housing back to the compressor.
